(19) United States
(12) Patent Application Publication
(10) Pub. No.: US 2010/0230272 A1
(43) Pub. Date: Sep. 16, 2010

(54) METHOD AND APPARATUS FOR USING HYDROGEN

(76) Inventors: Fidel Franco Gonzalez, Barcelona (ES); Alexandra Miguel Sanchez, Barcelona (ES); Alberto Ruiz Rodriguez, Martorell (ES)

Correspondence Address: BUCHANAN, INGERSOLL & ROONEY PC, POST OFFICE BOX 1404, ALEXANDRIA, VA, 22313-1404, US

(21) Appl. No.: 12/740,485

(22) PCT Filed: Nov. 11, 2008
(86) PCT No.: PCT/ES08/00697

§ 371 Date: Apr. 29, 2010

(30) Foreign Application Priority Data
Nov. 14, 2007 (ES) P200703012

(51) Int. Cl. C01B 3/02; B01J 19/12

(52) U.S. Cl. 204/157.43; 422/186.23

(57) ABSTRACT

The invention relates to a method and apparatus for using hydrogen. The method is characterised in that water from a sea water or other source if first preheated using solar energy and next subjected to a heating step in order to obtain steam which is transformed into water plasma at a low temperature, followed by the decomposition of the plasma by hydrolysis using electrodes and the subsequent separation of the hydrogen and oxygen obtained. The hydrogen is then transported to the location at which water is to be generated, the hydrogen undergoes oxidation and the energy therefrom is recovered, with water being regenerated for direct use.

The present invention is designed to make known a method for using hydrogen and its corresponding apparatus, which make it possible both to obtain hydrogen and use it in the generation of liquid water in the desired location, and which invention has significant characteristics of novelty and inventive step.

As is known, at present we are living in a period in which deserts are expanding, and this is affecting the Mediterranean fringe, including in countries such as Spain, Greece and Italy. Furthermore, as a consequence of climate change caused by the so-called greenhouse effect, the process of expansion of the desert has been accentuated.

The situation is so serious that, years ago, scientific circles and people who are aware of it warned about the dangers which are imminent if we do not seek solutions to the problems of desertification. For this reason, the present project has been developed for prevention of, and as a strategic solution to, these problems.

The present invention is designed to provide an economically feasible and technically satisfactory solution for obtaining hydrogen, for the purpose of permitting subsequent use of the latter in the reconstitution of water in situ, and optionally also for the generation of energy.

Various methods are known in the prior art currently available for obtaining hydrogen, for example based on organic materials such as natural gas. However, it is obvious that this is not an adequate source, since it is not very abundant, and has other applications. It is used in cases in which the industrial sector needs very pure hydrogen. There are also fermentation processes which can also provide hydrogen, however the quantities produced are small. For this reason, the present project relates to the most abundant source of hydrogen, i.e. sea water.

The process which is used at present to obtain hydrogen is the decomposition by electrolysis of a liquid plasma, in other words using an electric current to break down what is known in physics as a plasma (conductive fluid), which is prepared however using saline aqueous solutions of sodium carbonate.

Other means exist for obtaining plasmas from steam, for example capacitive plasmas formed on the basis of electric discharges which cause a low-density gas to undergo a transition process in such a way that it is converted into an excellent conductor. The problem is that, if the water plasma decomposes and forms hydrogen and oxygen, the apparatus may explode when the two gases recombine explosively. It has also been attempted to produce aqueous plasmas by means of soluble salts in hot steam, but these give very low yields.

Finally, it is possible to generate so-called thermal plasmas, which are obtained by heating steam to very high temperatures (3700° C.) by means of concentration of solar radiation, or by using the thermal energy which is released in nuclear plants. All of these means require very high energy consumption. The first method has a low cost, but depends on the existence of solar radiation, and in the case of the nuclear plants the yields are very low, since the decomposition of the plasma reaches a value of only 40%, apart from the fact that it is necessary to re-design new nuclear plants for this purpose. The inventors have carried out many studies and experiments in order to improve the methods for obtaining hydrogen. In particular, the present invention is designed to obtain low-temperature plasmas from steam, since, it has been found in the theoretical models developed by the inventors, that it is possible to obtain low-temperature plasma from steam by means of the application of scalar electrical fields, with a sinusoidal wave form, the frequency of which is in the microwave range, the scalar electrical fields acting in resonance with the absorption peaks of the steam spectrum, in the microwave range. This means that the steam which is subjected to the intense radiation of microwaves undergoes a transition process and acquires the properties of plasma, i.e. a diamagnetic fluid with excellent conductivity and absorption peaks at very low values. To this end it is acted by means of resonance, choosing the geometry of the container. The apparatus designed by the inventors in order to implement the method substantially comprises an electromagnetic wave heater with an icosahedral structure, and a plasma generator with an octahedral structure, in which the pressure and temperature of the steam can be varied, thus converting the latter into plasma, and also comprising the use of electromagnetic waves in the form of scalar electrical fields (or fields with scalar potential) of microwaves, in order to optimise the process. Consequently there will preferably be a plurality of apparatuses in parallel, for example three, in order to maintain a constant rate of production.

On the basis of the water plasma, it is possible to decompose water and separate the corresponding gases by means of electrolysis, with the use of two electrodes which are supplied with direct current in an apparatus with a geometric form, and functioning similar to the plasma generator. The hydrogen and oxygen will be separated independently into pressure tanks.

After the gases have been separated, they will be supplied to the storage tanks in which they will be compressed, and will be prepared for transport by means of the most appropriate procedure. The power supplied to the pumps for this process (as well as those of the entire installation) will be provided by means of renewable energy, or night-time supply from the mains.

Just as for the plasma generator, three elements are provided in parallel, arranged in series with the latter, in order to maintain a constant rate of production. The supply to the electrolyser of each plasma generator will take place without any cross-flow.

After the hydrogen has been obtained, the method for use of the latter according to the present invention includes transport of the hydrogen to the required locations, in which the hydrogen will be re-combined with oxygen in the air in order to obtain water once again in the required location. The aforementioned re-combination can be carried out by means of alternative thermal engines, turbines, or fuel cells, which will make it possible to obtain water and energy once again which can be used for general purposes. In relation with the present invention, account must be taken of the fact that the scalar electrical fields which are obtained in the interior of the octahedron have a far greater effect, since the transformation is far greater within the material. In fact, the energy of the scalar electrical fields decreases the internal energy of the material, but this decrease is virtually limitless, since instead of being used to create currents, it acts directly on the structure of the material. The bonds between the hydrogen and oxygen are weakened, on the basis of the action on the components of the water themselves, and the bonds ultimately separate.

A characteristic of the scalar electrical fields is that, there are no currents involved, nor are there magnetic fields involved, and this is a fundamental fact in the entire process of decomposition of the plasmas. In fact, if the intention is to decompose the water formed by the combination of the two initial gases, it is necessary to act on the plasma in order to obtain the separation of the hydrogen and oxygen, by changing the bond between the two by means of the scalar electrical fields. However, if thermal gradients or any type of instability occur in the interior of the plasma, these vectorial fields create currents which generate vectorial magnetic fields, including scalar electrical fields, the effects of which are contrary to the scalar electrical field, in other words, there is a tendency to restore the energy of the components of the water which are intended to be separated. To summarise, the currents which are induced by any type of instability contribute towards the re-combination of the gases, and the loss of efficiency of the process. For this reason it is a matter of priority to select “stable” geometries which contribute towards providing the plasma with stability.

In general, any type of instability will provide energy not only to the plasma, but to any intermediate process, and consequently the criterion of maximum stability will be used as the design criterion for all the elements or apparatuses used in the different stages of the production of the hydrogen.

With reference to the selection of the geometrical structure for the plasma generator and the electrolyser, it has been found that platonic solids, with the exception of dodecahedrons, have stable geometries, but to different extents. If we begin our analysis with a cube, it is found that this body has the lowest level of energy. In addition, cubic geometry would be unpractical, and therefore unsuitable for our objectives. This is followed by the icosahedron, and finally the octahedron. Since any type of instability in the evaporation process and in the process of generation of the plasma will contribute towards a loss of energy, and a decrease in the efficiency of all the processes, the icosahedron has been selected as the geometry which is most appropriate for the evaporator, and the octahedron has been selected as the one most appropriate for the electrolyser.

As far as the selection of materials is concerned, in the icosahedron of the evaporator there are no major problems, since the water to be evaporated cannot contain contaminants at a high steam pressure, and it is therefore sufficient to select stable materials consisting of steel or nickel steel. However, the upper surfaces of the icosahedron do not only act as an enclosure for the shape, but also are intended to act as antennae, or as a support for the directional antennae which emit microwave radiation, and heat the water which is contained in the icosahedron. These surfaces are in contact with the steam only if the water is sea water, or is uncontaminated.

It must be considered that, within the octahedron, the inner surfaces which are in contact with the plasma, apart from being an enclosure, also act as antennae which emit the microwave fields in resonance with the absorption peaks of the steam spectrum in this frequency range, and may suffer from a process of cold fusion which would affect the emitter antennae and rapidly make the materials deteriorate. For this reason, these surfaces would have to be covered by a resistant and stable material, in view of the high level of reactivity of the plasma.

The sea water will enter the evaporator via piping which is situated in the lower part of the icosahedron, through which the brine will also be drained off.

On the whole sea water which is collected at the statutory distance from the coast will be used and supplied to the pumps by means of energy which is preferably produced in a renewable energy unit, or by means of night-time supply of the network. The water is then pre-heated by means of solar energy, using known technologies for hot domestic water or the like, and with the possibility of direct generation of steam by means of thermo-solar procedures. When the water is at a certain temperature, it will be introduced into a heater in order to obtain the appropriate temperature and pressure by means of the use of electro-magnetic waves, such that, when the water is evaporated, it will leave a residue in the form of brine which will be returned to the sea, or will be able to be sold under certain conditions.

For a better understanding of the invention, and by way of explanatory but non-limiting example, schematic drawings which explain the present invention are appended.

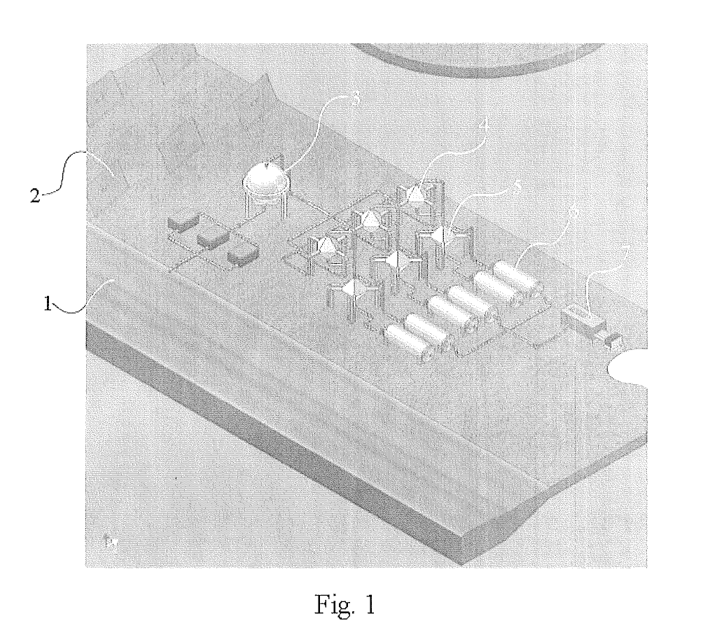

FIG. 1 schematically shows the set of elements used for the generation of hydrogen according to the present invention.

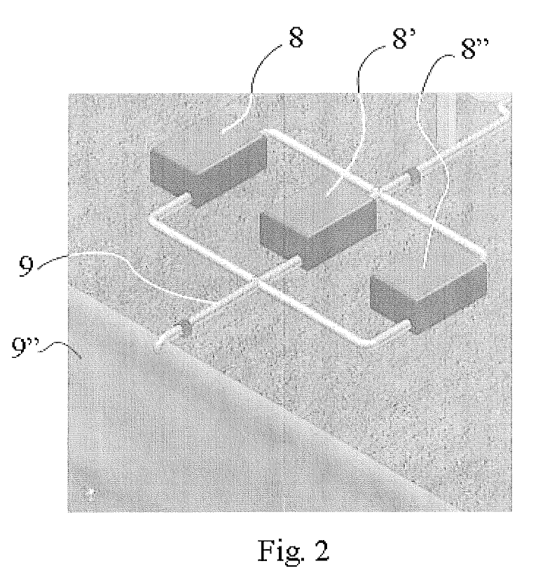

FIG. 2 shows the capturing and pre-heating of the water in detail.

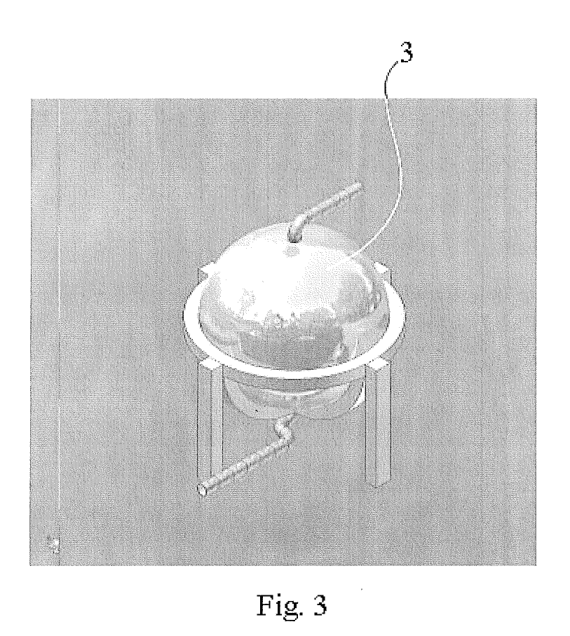

FIG. 3 schematically shows a heater-evaporator on an enlarged scale.

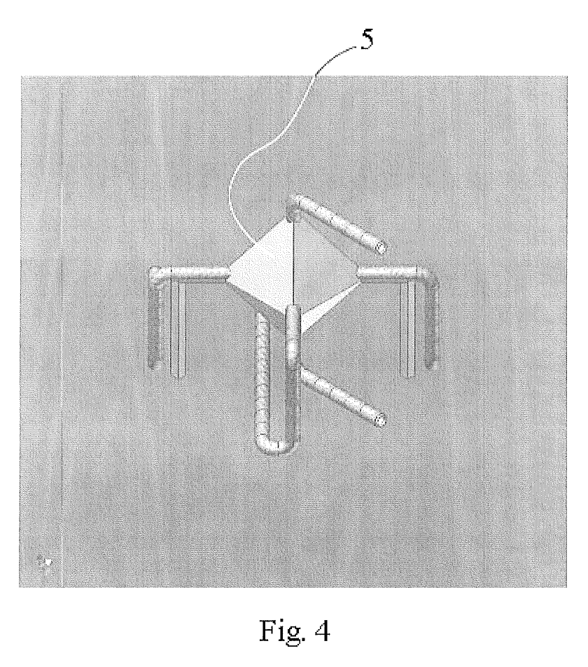

FIG. 4 is a perspective view of a plasma generator.

The invention is based on an abundant source of water, for example which originates from the sea or is of another type, represented by numeral 1 in FIG. 1, and on separate generation of electricity, for example by means of an installation 2 for supply of solar energy, with pre-heating of the water and conversion of the latter into steam in a heater-evaporator device 3, by means of vectorial electromagnetic waves, after which the steam in the generators 4 is transformed into plasma. Subsequently the plasma generated is transferred to the electrolysers 5, in which the decomposition of the plasma into hydrogen and oxygen is carried out by means of electrodes and by the activation of electromagnetic waves. The hydrogen and oxygen which are discharged from the electrolyser respectively via the upper and lower vertices of the octahedron will be stored in tanks 6, from which, and by means of a pressurisation and pumping station 7, they will be transferred via piping, tanks or other means to the places of supply.

FIG. 2 shows three units in parallel 8, 8′ and 8″ for pre-heating of the water which is collected from the mass of sea water or water of another type 1 by means of the piping 9.

The water will previously be heated to a level of approximately 50° C., and the subsequent heating will be carried out in the heating device by means of electrical vectorial fields of microwaves which are in resonance with the absorption peaks of the water, such that the electrical vectorial fields of microwaves heat and evaporate the water if their power is sufficient, and the electrical vectorial field of microwaves contributes towards the decrease in internal energy of the water, thus assisting the processes of creation of the plasma. If the phase transition takes place at a pressure which is greater than atmospheric pressure, the latent heat decreases, and increases as the pressure decreases. In order to maintain a continuous process of generation of steam, a constant pressure value will be established which ranges between 0.5 bar and approximately 2 bars, reaching a maximum limit of 5 bars.

The steam will be generated by applying vectorial electrical fields of 2.16 GHz in resonance with the absorption peaks of the water previously heated by means of solar energy. In other words, the water is heated by the Joule effect by means of the energy dissipated by the vectorial electrical fields in resonance.

The steam will enter the electrolysers via the four vertices corresponding to the horizontal square of the octahedron, in order to obtain homogeneous distribution.

The evaporators will preferably have a stable geometry such as an icosahedron, most of the volume of the latter being occupied by water and the remainder by steam.

The electrodes will preferably be flat, acting as directional antennae located outside the water, since sea water conducts electricity.

The method of reducing the possible formation of magnetic fields consists of using discrete electrodes which are located on some of the surfaces of the icosahedron.

In order to avoid problems of corrosion, the surface of the electrodes will be covered with a stable metal such as nickel, or based on a special steel which is resistant to corrosion.

For the dimensions of the icosahedron, it is envisaged that the radius of the sphere which surrounds the icosahedron is 3 metres. Consequently:

$$V = \frac{5}{12} {a}^{3} ( 3 + \sqrt{5} ) ≅ 2 , 1817 {a}^{3}$$

where a=3.15438 metres when the radius R is 3 metres and V=2.5359991R³=68.47 m³.

Once the hydrogen and oxygen have been obtained separately and are duly stored, it will be possible to use oxygen to the industrial sector, and the hydrogen will be able to be transported at a suitable pressure and temperature by piping or other means, to the locations in which it is wished to generate water since the latter is in short supply naturally, and may be used by any of the means previously indicated.

Although the invention has been described with reference to preferred embodiments only as examples, these should not be considered to limit the invention, which will be defined by the broadest interpretation of the following claims.

1. A method for the production of hydrogen, comprising:
a) pre-heating water
b) exposing the pre-heated water to a vectorial field of microwaves sufficient to convert the water to steam;
c) exposing the steam to scalar fields of microwaves such that the steam is transformed into water plasma;
decomposing the plasma by exposure to electromagnetic waves; and
e) separately collecting hydrogen and oxygen from the decomposition of the water plasma.

2. The method of claim 1, wherein the pre-heating of water is carried out by heating said water to a temperature of between approximately 40 and 60° C.

3. The method of claim 2, wherein the pre-heating of water is carried out by heating said water to a temperature of approximately 50° C.

4. The method of claim 1, wherein the electrical vectorial fields of microwaves are in resonance with the absorption peaks of the water.

5. The method of claim 4, wherein the heating of the water takes place with formation of steam at a pressure of between about 0.5 bar and 5 bars.

6. The method of claim 5, wherein the formation of steam is at a pressure of approximately 2 bars.

7. The method of claim 1, wherein the steam is transformed to a plasma by scalar fields of microwaves generated by the superimposition of electrical vectorial fields of microwaves emitted by directional antennae, the vectorial sum of which is zero.

8. (canceled)

9. The apparatus of claim 20, further comprising water intake and discharge at the lower part of the steam chamber.

10. The apparatus of claim 20, wherein the electrodes are flat electrodes that act as directional antennae.

11. (canceled)

12. The apparatus of claim 10, wherein the electrodes are covered by a corrosion-resistant stable metal.

13. The apparatus of claim 22, wherein each of the surfaces of the octahedron act as antennae to emit radiation in a direction perpendicular to each surface of said octahedron to generate an electrical vectorial field of zero or a scalar electrical field.

14. The apparatus of claim 20, comprising multiple plasma chambers.

15. (canceled)

16. (canceled)

17. The apparatus of claim 20, further comprising piping effecting discharge of hydrogen and oxygen from the plasma chamber via the upper and lower vertices of the octahedral structure.

18. The apparatus of claim 20, wherein the electrodes are configured to be charged by direct current.

19. The apparatus of claim 18, wherein the electrodes have a positive pole and a negative pole, and are configured such that the positive pole is closer to the lower vertex, and the negative pole is closer to the upper vertex.

20. An apparatus for the production of hydrogen, comprising:
a) a pre-heating chamber comprising a water heater;
b) a steam chamber in fluid communication with said pre-heating chamber and comprising a microwave generator capable of producing a vectorial microwave field within said chamber sufficient to convert water to steam;
c) a plasma chamber in fluid communication with said steam chamber and comprising:
i) a microwave generator capable of producing a scalar microwave field sufficient to transform steam to a water plasma; and
ii) electrodes generating an electromagnetic field sufficient to decompose the plasma; and
d) gas storage tanks in fluid communication with said plasma chamber.

21. The apparatus of claim 20, wherein the steam chamber is an icosahedral structure.

22. The apparatus of claim 20, wherein the plasma chamber is an octahedral structure.

23. The apparatus of claim 20, wherein the water heater is a solar heating device.

24. The apparatus of claim 20, wherein the microwave generator of the steam chamber produces vectorial electrical fields of at least 2.16 GHz in resonance with absorption peaks of water.

25. The apparatus of claim 22, comprising a steam inlet to the octahedron chamber at each of the vertices corresponding to the horizontal square of the octahedron.
